(19) United States
(12) Patent Application Publication
(10) Pub. No.: US 2010/0020012 A1
(43) Pub. Date: Jan. 28, 2010

(54) CHARACTER INPUT DEVICE

(76) Inventor: Eui Jin OH, Daejeon (KR)

Correspondence Address: LEXYOUME IP GROUP, LLC, 5180 PARKSTONE DRIVE, SUITE 175, CHANTILLY, VA, 20151, US

(21) Appl. No.: 12/526,532

(22) PCT Filed: Feb. 13, 2008
(86) PCT No.: PCT/KR2008/000861

§ 371 Date: Aug. 10, 2009

(30) Foreign Application Priority Data
Feb. 13, 2007 (KR) 10-2007-0014916
Oct. 12, 2007 (KR) 10-2007-0103095

(51) Int. Cl. G09G 5/08; G09G 5/00; G06F 3/041

(52) U.S. Cl. 345/160; 345/156; 345/184; 345/173

(57) ABSTRACT

The present invention relates to a character input device. The character input device includes a first directional input unit (10) provided such that first directional input, which is performed through selection of one from among a plurality of first direction indication locations, arranged radially around a reference location and spaced apart from one another, can be performed. Second directional input units (50) are provided such that second directional input, which is performed through selection of one from among a plurality of second direction indication locations, arranged radially outside the first directional input unit and spaced apart from one another, can be performed. A first directional input detection unit (61) detects the first directional input. A second directional input detection unit (65) detects each second directional input. A control unit is configured to extract and input character codes assigned to the first and second direction indication locations.

### TECHNICAL FIELD

The present invention relates, in general, to a character input device, and, more particularly, to a character input device, in which a plurality of second directional input units is provided outside a first directional input unit, capable of performing directional input, thus enabling each character to be precisely input according to a user's intention while minimizing the space required for character input.

### BACKGROUND ART

With the development of software and semiconductor technology and data processing technology, information devices are gradually becoming small, and the amount and importance of characters input using such information devices is gradually increasing.

Meanwhile, the input of various characters or instructions to such information devices exhibits many problems. For example, input devices, such as keyboards, used in Personal Computers (PCs) or notebook computers cause difficulty in realizing small-sized information devices because there is a limitation on the reduction in the size thereof, and touch screen schemes used in Personal Data Assistants (PDAs) and keypad schemes used in mobile phones are inconvenient because the speed of input is slow and the incidence of erroneous input is high.

In order to input letters, numbers and symbols to the above-described information devices, such as PCs, notebook computers, PDAs or mobile phones, at a higher speed, it is necessary to perform a so-called one stroke-one phoneme input, in which one phoneme character is input through one input action at a higher speed. When such one stroke-one phoneme input is applied to the Korean alphabet, it is necessary to provide buttons or input keys for inputting 24 or more characters on an information device. When the target language of input is English, Japanese or some other language, a larger number of buttons or input keys is required than in the case of the Korean alphabet.

However, since conventional input devices used in various types of information devices adopt a scheme of assigning characters to respective input keys and inputting the characters by striking or pressing the input keys using fingers, it is difficult to arrange 24 or more finger-sized input keys on a personal mobile information terminal having a small area for the arrangement of input keys, such as a mobile phone.

This is the reason why it has been difficult to realize small-sized keyboards to date. In the case of mobile phones, since 24 or more Korean alphabet letters are input using only 12 buttons, it is inevitable to arrange a plurality of letters on each button, with the result that a repeated input phenomenon, in which an input action is repeated twice or three times to input one letter (phoneme), occurs frequently. Accordingly, input is slow and inconvenient.

Although a character input method of inputting characters through combination, known as Cheonjin, has been proposed in order to overcome the above problem the repeated input phenomenon is not solved using this method.

Furthermore, technologies, including a roll-up keyboard, which can be rolled up and then carried, and a virtual laser keyboard, which is configured to project an image of a keyboard onto a surface, detect the locations of fingers when actions similar to keyboard input actions are perform on the image using the fingers and receive input, have be proposed.

However, such types of input devices have problems in that they are inconvenient in that they must always be carried, and in that the types of input device are not suitable for application to personal portable information terminals requiring input in the state in which the personal portable information terminals are held in the hands while moving because input can be performed only in the state in which those types of input devices are placed on support surfaces.

### DISCLOSURE OF INVENTION

### Technical Problem

Accordingly, the present invention has been made keeping in mind the above problems occurring in the prior art, and an object of the present invention is to provide a character input device that is capable of precisely inputting each character according to a user's intention while minimizing the space required for character input.

Another object of the present invention is to provide a character input device that is capable of inputting data on a keyboard, such as characters, numerals and symbols, by manipulating a first directional input unit and a second directional input unit on various types of portable electronic devices, such as Personal Digital Assistants (PDAs), notebook computers, and portable mobile communication terminals.

A further object of the present invention is to provide a character input device, in which one complete character can be arranged to correspond to each signal by enabling a maximum number of pieces of data to be arranged in a narrow space.

Yet another object of the present invention is to provide a character input device that is capable of performing directional input together through a first directional input unit and a second directional input unit using a single finger.

### Technical Solution

In order to accomplish the above objects, the present invention provides a character input device, comprising a first directional input unit provided such that first directional input, which is performed through selection of one from among a plurality of first direction indication locations, arranged radially around a reference location and spaced apart from one another, can be performed; a second directional input unit provided such that second directional input, which is performed through selection of one from among a plurality of second direction indication locations, arranged radially outside the first directional input unit and spaced apart from one another, can be performed; a first directional input detection unit configured to detect the first directional input; a second directional input detection unit configured to detect each second directional input; and a control unit configured to extract and input character codes assigned to the first and second direction indication locations on a basis of results of detection of the first directional input detection unit and the second directional input detection unit.

At least one of the first and second directional input units may be provided to enable directional input to be performed in two or more stages, that is, in multiple stages.

The first and second directional input units may be provided in two sets.

Central input that is performed using either one of a method of moving the entire first directional input unit in a vertical direction and a method of selecting a central input key provided on the first directional input unit can be performed.

When the first or second directional input is performed in a case in which the central input is performed, a new character code assigned to the case may be input.

When the central input is performed in a case in which the first or second directional input is performed, a new character code assigned to the case may be input.

When the first directional input and the second directional input are performed to overlap each other, character codes assigned to the overlapping inputs may be input.

The character codes assigned to the overlapping inputs may differ according to a sequence of the first and second directional inputs.

The first directional input unit may be configured to perform the first directional input by horizontally moving toward any one of the plurality of first direction indication locations from the reference location.

The first directional input unit may be formed in a shape of a stick, in which a lower portion is supported at the reference location and an upper portion is tilted at any one of the plurality of first direction indication locations, thus performing the first directional input.

The first directional input unit may be formed in a shape of a disk, and may further comprise a support unit, which is placed on a bottom of the first directional input unit and is configured to support the first directional input unit so that the entire first directional input unit can be tilted at each of the first direction indication locations, thus performing the directional input.

The first directional input unit may comprise a plurality of direction pressing keys corresponding to respective first direction indication locations.

One or more of the first directional input unit, the second directional input unit and the central input key may be provided to enable input to be performed in two or more stages, that is, multiple stages.

One or more of the first directional input unit, the second directional input unit and the central input key may be provided to additionally have a touch input function of detecting contact or approach of a finger.

Characters may be assigned to one of the first direction indication locations and the second direction indication locations, and symbols, numerals, or functions, such as enter, space, cancel and mode change, may be assigned to a remaining one thereof.

The plurality of second directional input units may be connected to each other and implemented as an integrated-type directional input unit.

The first directional input unit and the plurality of second directional input units may be provided close to each other so that, in a state in which one of the first directional input and second directional input is performed using one finger, a remaining one thereof is performed without removing the finger from the character input device.

The second directional input units may be connected and integrated into a shape of a ring.

The second directional input units may be connected and integrated into a shape of a polygon.

The central input key, the first directional input unit and the second directional input units may be provided to have sequentially decreasing heights.

The first directional input unit and the second directional input units may be used as a mouse or a joystick.

When a mode is switched to a mouse or joystick mode, movement of a mouse pointer or characters may be performed using one of the first directional input unit and the second directional input units, and manipulation of left/right buttons of the mouse or manipulation of characters may be performed using a remaining one thereof.

The second directional input units may be connected and integrated into a shape of a ring so that continuous operation is possible while sliding on the second directional input units is performed.

The character input device may further comprise a center touch detection unit provided on the central input key and configured to detect contact of a finger, wherein the control unit is operated to ignore results of detection performed by the center touch detection unit when contact of the finger is detected by the center touch detection unit for a predetermined period of time or longer, thus preventing touch input from being performed by the center touch detection unit.

The character input device may further comprise a center touch detection unit provided on the central input key and configured to detect contact of the finger, wherein the control unit is operated to input different characters by discriminating between a case where a center touch detection signal, obtained through contact of the finger detected by the center touch detection unit, and a detection signal, detected by the first directional input detection unit through performance of the first directional input, are simultaneously received, and a case where only a detection signal, detected by the first directional input detection unit, is received.

### Advantageous Effects

According to the character input device of the present invention, a plurality of second directional input units is provided outside a first directional input unit, capable of performing directional input, thus enabling each character to be precisely input according to a user's intension while minimizing the space required for character input.

Further, according to the present invention, the input space can be minimized, so that the small size and slim structure of products can be realized, and thus application to various types of portable electronic devices, such as PDAs, notebook computers and portable mobile communication terminals, is possible.

Furthermore, according to the present invention, there is an advantage in that, since a maximum number of pieces of data can be arranged in a narrow space, one complete character can be arranged to correspond to each signal, so that one-action one-phoneme input is possible, as in the case of a keyboard, and thus very fast input of characters can be conveniently performed.

In addition, according to the present invention, there is an advantage in that directional input can be performed together on a first directional input unit and on a second directional input unit using one finger, thus enabling faster input of characters and realizing the functions of a keyboard and a mouse, performed using desktop PCs, on various types of portable electronic devices using one finger.

### BRIEF DESCRIPTION OF THE DRAWINGS

FIG. 1 is a perspective view showing a portable mobile communication terminal equipped with a character input device according to the present invention;

FIG. 2 is a plan view showing a character input device according to a first embodiment of the present invention;

FIG. 3 is a partially cut away perspective view showing a character input device according to a second embodiment of the present invention;

FIGS. 4 and 5 are diagrams showing the operation of the second embodiment of the present invention, which show sectional views taken along line A-A′ of FIG. 1;

FIG. 6 is a partially cut away perspective view showing a character input device according to a third embodiment of the present invention;

FIG. 7 is a partially cut away perspective view showing a character input device according to a fourth embodiment of the present invention;

FIG. 8 is a sectional view showing the character input device according to the fourth embodiment of the present invention;

FIG. 9 is a sectional view showing a character input device according to a fifth embodiment of the present invention;

FIG. 10 is a plan view showing the character input device according to the fifth embodiment of the present invention;

FIG. 11 is a perspective view showing a character input device according to a sixth embodiment of the present invention;

FIG. 12 is a plan view showing a touch detection method performed using the second directional input unit of the character input device of FIG. 11;

FIG. 13 is a perspective view showing a character input method according to the sixth embodiment of the present invention;

FIGS. 14 and 15 are configuration diagrams showing a character input method according to the sixth embodiment of the present invention;

FIGS. 16 to 18 are diagrams showing examples of modifications of the sixth embodiment of the present invention; and

FIGS. 19 and 20 are configuration diagrams showing a character input device according to a seventh embodiment of the present invention.

### MODE FOR THE INVENTION

Hereinafter, embodiments of the present invention will be described in detail with reference to the attached drawings.

Prior to the description, it is disclosed in advance that various types of first directional input units 10, shown in the drawings attached to the present specification, are embodiments required to describe the present invention in detail, and can be applied to all types of first directional input units 10 disclosed in Korean Patent Appln. No 2006-0120368, filed by the present applicant on Dec. 1, 2006 and entitled ‘character and data input device and method’.

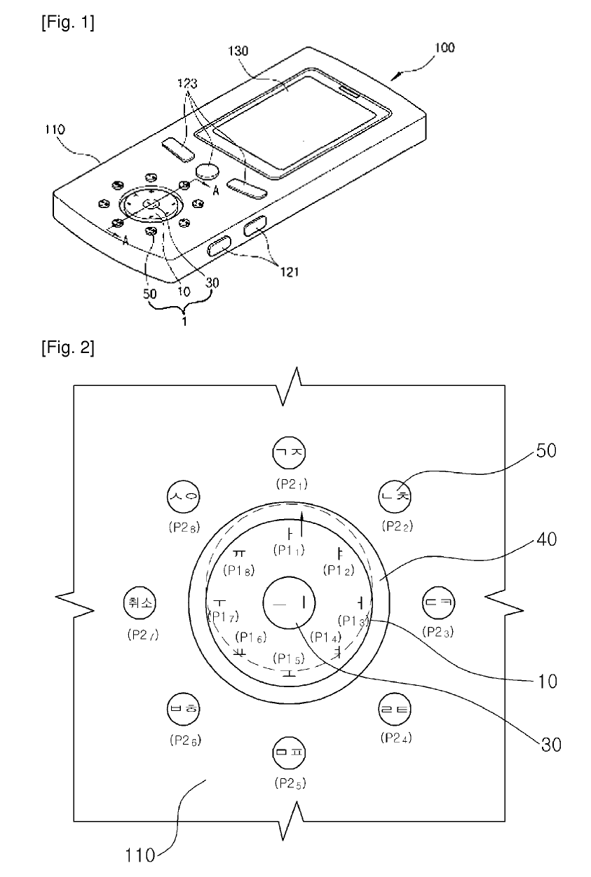

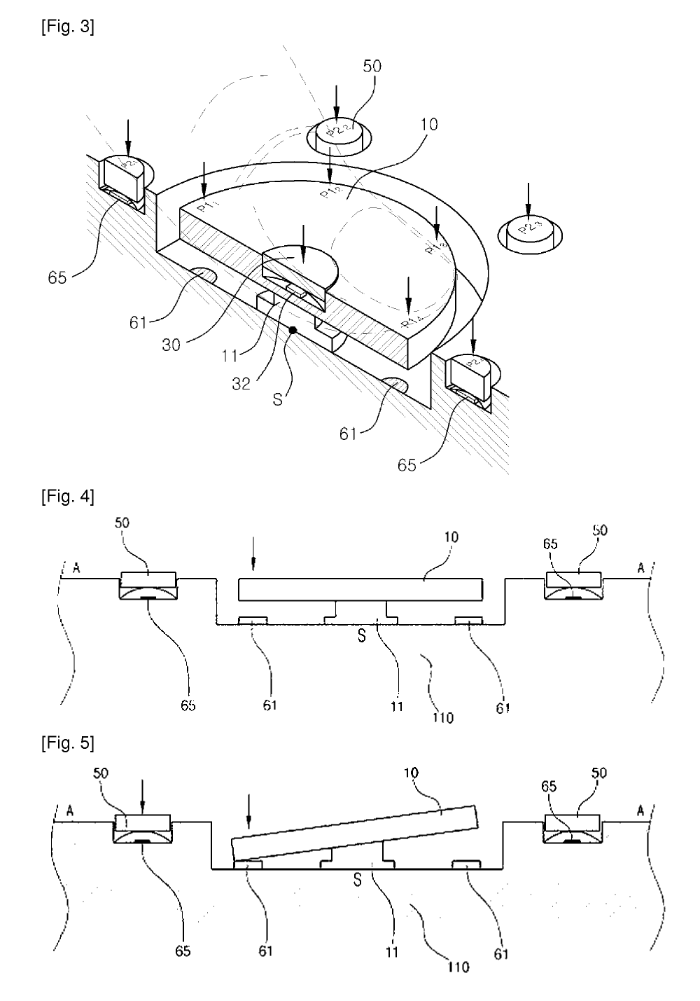

Referring to FIG. 1, a character input device 1 according to the present invention includes a first directional input unit 10 provided such that first directional input, which is performed through the selection of one from among a plurality of direction indication locations P1₁, P1₂, P1₃, P1₄, . . . , arranged radially around a reference location S and spaced apart from one another, can be performed; a plurality of second directional input units 50 provided such that second directional input, which is performed through the selection of one from among a plurality of second direction indication locations P2₁, P2₂, P2₃, P2₄, . . . , arranged radially outside the first directional input unit 10 and spaced apart from one another, can be performed; a first directional input detection unit 61 (refer to FIG. 3, etc.) configured to detect the first directional input; a second directional input detection unit 65 (refer to FIG. 3, etc.) configured to detect the second directional input; and a control unit (not shown) configured to extract character codes, assigned to relevant first and second direction indication locations P1 and P2, on the basis of the results of detection of the first directional input detection unit and the second directional input detection unit and inputting the character codes.

The character input device 1 according to the present invention is provided on one side of a casing 110 of a portable mobile communication terminal 100, and a display unit 130, on which various types of characters, numerals, symbols or commands, input through the character input device 1, are displayed, is provided on the other side of the case 110.

FIG. 2 is a plan view showing a character input device 1 according to a first embodiment of the present invention.

Referring to the drawing a first directional input unit 10 is provided to be horizontally movable toward respective first direction indication locations P1₁, P1₂, P1₃, P1₄, . . . , within a range of a predetermined input radius provided on a casing 110.

The first directional input unit 10 can be formed to have various shapes, for example, a circular shape, as shown in FIGS. 1 and 2, a rectangular shape, or a ring shape having an opening in its center portion.

The first direction indication locations P1₁, P1₂, P1₃, P1₄, . . . are arranged radially around the reference location S (refer to FIG. 3) of the first directional input unit 10, and are spaced apart from one another.

The number of first direction indication locations P1₁, P1₂, P1₃, P1₄, . . . can be changed according to the circumstances, for example, to correspond to eight directions, as shown in FIG. 2, four directions, or 12 directions. Of course, in addition to the examples, the number of first direction indication locations can be set to other values.

One or more different characters are allocated to each of the first direction indication locations P1₁, P1₂, P1₃, P1₄, . . . . That is, the vowel [symbol] of the Korean alphabet is placed on the first direction indication location P1₁, and the vowel [symbol] of the Korean alphabet can be placed on the first direction indication location P1₆.

In this case, the type of characters assigned is not limited, and a consonant of the Korean alphabet or a consonant or vowel of the English alphabet may be assigned, and in addition, numerals, symbols or functions, such as enter, space and cancel, can be arranged on the first direction indication location.

Meanwhile, when the first directional input unit 10 is provided to perform directional input in two or more stages, that is, in multiple stages, two or more characters may be assigned together to each of the first direction indication locations P1_{1,}P1₂, P1₃, P1₄, . . . .

For example, when two-stage directional input is possible depending on the difference in the distance of movement to the first directional input unit 10, two different characters may be assigned together to each of the first direction indication locations P1₁, P1₂, P1₃, P1₄, . . . .

In this case, the multi-stage input of the first directional input unit 10 can be implemented by, for example, sequentially providing two first directional input detection units 61, having different distances from the reference location S, on the movement path of the first directional input unit 10.

Alternatively, a first directional input detection unit 61 is implemented using a typical optical sensor used for a mouse, which is an auxiliary input device, so that multi-stage input can be distinguished depending on the displacement of the first directional input unit 10 from the reference location S. Furthermore, the multi-stage input may be performed by distinguishing pressure values applied to the first directional input unit 10, rather than the displacement, and recognizing the difference between the pressure values.

Meanwhile, a plurality of second directional input units 50 is provided such that second directional input, which is performed through the selection of one from among a plurality of second direction indication locations P2₁, P2₂, P2₃, P2₄, . . . , arranged radially along the outer circumference of the first directional input unit 10 and spaced apart from one another by a predetermined distance, can be performed.

Of course, the number of second direction indication locations P2₁, P2₂, P2₃, P2₄, . . . of the second directional input units 50 may be changed according to the circumstances. Further, one or more different characters are assigned to each of the second direction indication locations P2₁, P2₂, P2₃, P2₄, . . . . For example, the consonant [symbol] of the Korea alphabet is arranged at one second direction indication location P2₁, and the consonant [symbol] of the Korean alphabet is arranged at another second direction indication location P2₂.

Meanwhile, the second directional input units 50 may be implemented in various types of directional input units, for example, pressing button-type directional input units, as shown in FIGS. 2 and 4, touch-type directional input units, or pressing pressure detection-type directional input units.

Further, in each of the above-described embodiments, the second directional input units can be provided to enable input to be performed in two or more stages, that is, in multiple stages, and can be provided using two or more of the above-described types together.

For example, when the second directional input detection unit 65 is implemented using both a touch sensor and a pressing contact sensor at the second direction indication location P2₁ of the second directional input units 50 of FIG. 2, [symbol] may be input by the contact of a finger, and [symbol] may be input by a press. Further, when the second directional input units 50 are provided in two stages depending on the difference in the pressing distance, [symbol] may be input by a first-stage press, and [symbol] may be input by a second-stage press.

Here, the number of first direction indication locations P1₁, P1₂, P1₃, P1₄, . . . and the number of second direction indication locations P2₁, P2₂, P2₃, P2₄, . . . may be equal to each other, or may be different from each other.

Meanwhile, characters can be assigned to each of the first direction indication locations P1₁, P1₂, P1₃, P1₄, . . . and each of the second direction indication locations P2₁, P2₂, P2₃, P2₄, . . . using various methods. For example, as shown in FIG. 2, vowels of the Korean alphabet may be assigned to the first direction indication locations P1₁, P1₂, P1₃, P1₄, . . . and the consonants of the Korean alphabet may be assigned to the second direction indication locations P2₁, P2₂, P2₃, P2₄, . . . , thus enabling Korean vowels to be input through first directional input using the first directional input unit 10, and Korean consonants to be input through second directional input using the second directional input units 50.

Of course, in contrast, the consonants of the Korean alphabet may be assigned to the first direction indication locations P1₁, P1₂, P1₃, P1₄, . . . , and the vowels of the Korean alphabet may be assigned to the second direction indication locations P2₁, P2₂, P2₃, P2₄, . . . .

Meanwhile, the character input device 1 according to the present invention can be provided to perform central input.

As shown in FIG. 2, the central input is configured to include input performed by selecting a central input key 30 provided at the center of the first directional input unit 10, or pumping input performed by vertically moving the entire first directional input unit 10 up and down.

The central input can be provided to enable input to be performed in two or more stages, that is, in multiple stages, and characters, numerals, symbols or various commands, such as functions, can be assigned to the central input.

The number of characters that can be input through the above-described character input device may be a total of 16 in the case of a set of first and second directional input units 10 and 50, because eight characters are input through the first directional input unit 10 and eight characters are input through the second directional input units 50. Therefore, when the character input device 1 is implemented in two sets, one character is assigned to each of the first direction indication locations P1₁, P1₂, P1₃, P1₄, . . . of the first directional input unit 10 and the second direction indication locations P2₁, P2₂, P2₃, P2₄, . . . of the second directional input units 50, so that a total of 32 characters can be input.

Further, as described above, the number of first direction indication locations P1₁, P1₂, P1₃, P1₄, . . . and the number of second direction indication locations P2₁, P2₂, P2₃, P2₄, . . . are not limited to 8, but may be 4 or 12. In this case, when four first direction indication locations P1 and four second direction indication locations P2 are arranged and the first directional input unit 10 and the second directional input units 50 are provided to perform directional input in two stages at respective direction indication locations P1 and P2, a total of 16 characters can be input through the first directional input unit 10 and the second directional input units 50 (two characters are input at each of the direction indication locations of the first directional input unit 10 and the second directional input units 50). Therefore, when the first directional input unit 10 and the second directional input units 50 are implemented in two sets, a total of 32 characters can be input.

Meanwhile, when eight first direction indication locations P1 and eight second direction indication locations P2 are provided, and the first directional input unit 10 and the second directional input units 50 are provided to perform directional input in two stages, a total of 32 characters can be input using only a set of a first directional input unit 10 and second directional input units 50.

The number of characters that can be input through the character input device 1 according to the present embodiment may be 32 or more. Therefore, one phoneme of the Korean alphabet or English alphabet is arranged on each of the first direction indication locations P1 and the second direction indication locations P2, so that a one action-one phoneme relationship can be realized.

FIGS. 3 to 5 are sectional views showing a character input device 1 according to a second embodiment of the present invention. The character input device 1 according to the second embodiment of the present invention is configured such that directional input is performed by tilting the entire first directional input unit 10 at each of the first direction indication locations P1₁, P1₂, P1₃, P1₄, . . . in the state in which the first directional input unit 10 is fixed to a reference location S.

That is, referring to FIG. 4, as the entire first directional input unit 10 is tilted at the left portion thereof (at the portion close to direction A of FIG. 1 or at the direction indication location P1) while being supported by a support unit 11, the first directional input unit 10 comes into contact with a first directional input detection unit 61, and thus a character [symbol] , assigned to the first direction indication location P1₁, is input.

Alternatively, although not shown in the drawing attached to the present specification, pressing buttons corresponding to respective first direction indication locations P1₁, P1₂, P1₃, P1₄, . . . can be provided on the top of the first directional input unit 10.

Meanwhile, the second directional input units 50 according to the present invention may be connected to each other and implemented as an integrated-type directional input unit.

Therefore, when a character of the Korean alphabet is input through the character input device 1 according to the second embodiment of the present invention, a Korean consonant can be input by selecting a corresponding one of the second direction indication locations P2₁, P2₂, P2₃, P2₄, . . . of the second directional input units 50, and a Korean vowel can be input by successively tilting the entire first directional input unit 10 at a corresponding one of the first direction indication locations P1₁, P1₂, P1₃, P1₄, . . . (or by selecting a pressing button provided at the corresponding one of the first direction indication locations P1₁, P1₂, P1₃, P1₄, . . . ).

Similar to the first embodiment, when pressing buttons are formed on the first directional input unit 10, the pressing buttons and the second directional input units 50 may be provided in various types, for example, in one-stage touch, one-stage press/one-stage touch, one-stage press/first and second-stage press, and one-stage touch/first and second-stage press.

In this case, when the first directional input unit 10 has eight first direction indication locations P1₁, P1₂, P1₃, P1₄, . . . , and each pressing button is provided to enable input to be performed in a total of three stages, that is, touch, first-stage press, and second-stage press, 24 characters can be input using only the first directional input unit 10. Accordingly, a total of 24 characters are arranged on each of the first direction indication locations P1₁, P1₂, P1₃, P1₄, . . . of the first directional input unit 10 in such a way that three characters are assigned to each first direction indication location. Further, numerals, symbols, or functions, such as enter, space, cancel or mode change, other than the characters, may be assigned to each of the second direction indication locations P2₁, P2₂, P2₃, P2₄, . . . of the second directional input units 50.

FIG. 6 is a partially cut away perspective view showing a character input device according to a third embodiment of the present invention.

Referring to the drawing a first directional input unit 10 according to the present invention may be formed in the shape of a disk, and a central input key 30 may be arranged to be selected in the first directional input unit 10.

In this case, similar to the second embodiment of the present invention, the first directional input unit 10 is configured to perform first directional input, which enables the entire first directional input unit 10 to be tilted at any one of respective first direction indication locations P1₁, P1₂, P1₃, P1₄, . . . , arranged radially around the reference location S and spaced apart from one another, and enables the corresponding one to be selected.

Meanwhile, second directional input units 50 can be connected and integrated into the shape of a ring.

Such an integrated-type second directional input unit 50 is implemented such that, after characters assigned to respective second direction indication locations P2₁, P2₂, P2₃, P2₄, . . . are input, other data can be successively input by sliding a finger on the second directional input unit 50 without removing the finger from the second directional input unit 50.

For example, when the syllable [symbol] of the Korean alphabet is input using two fingers, the character combination can be completed by primarily inputting the consonant [symbol] of the Korean alphabet, assigned to the second direction indication location P2₁, using the first finger, and subsequently inputting the vowel [symbol] of the Korean alphabet, assigned to the first direction indication location P1₁, using the second finger.

When the syllable [symbol] of the Korean alphabet is input, the character combination can be completed by inputting the consonant [symbol] of the Korean alphabet, assigned to the second direction indication location P2₂, using the first finger in such a way as to slidably move the first finger to the second direction indication location P2₂ without removing the first finger from the integrated-type second directional input unit 50, and by subsequently inputting the vowel [symbol] of the Korean alphabet, assigned to the first direction indication location P1₁, using the second finger.

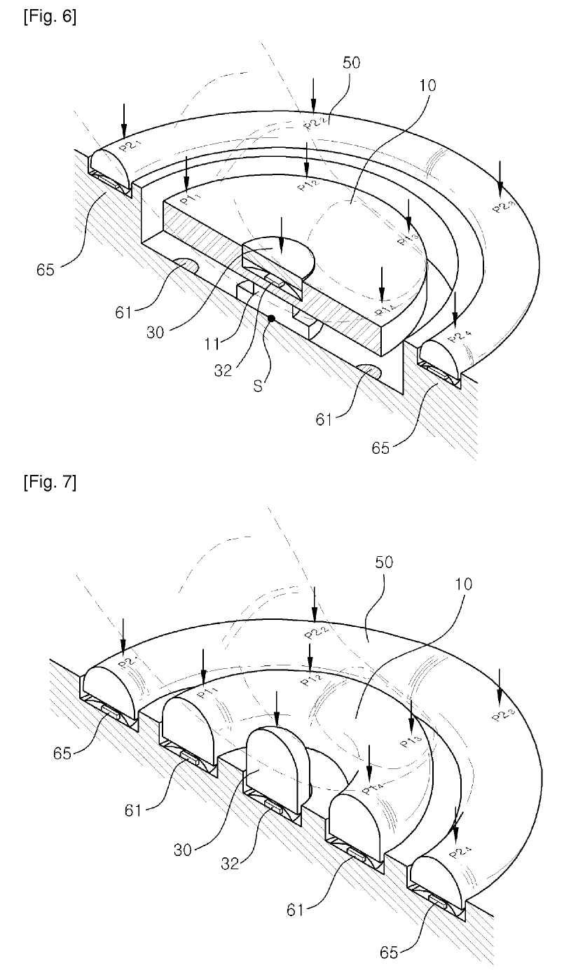

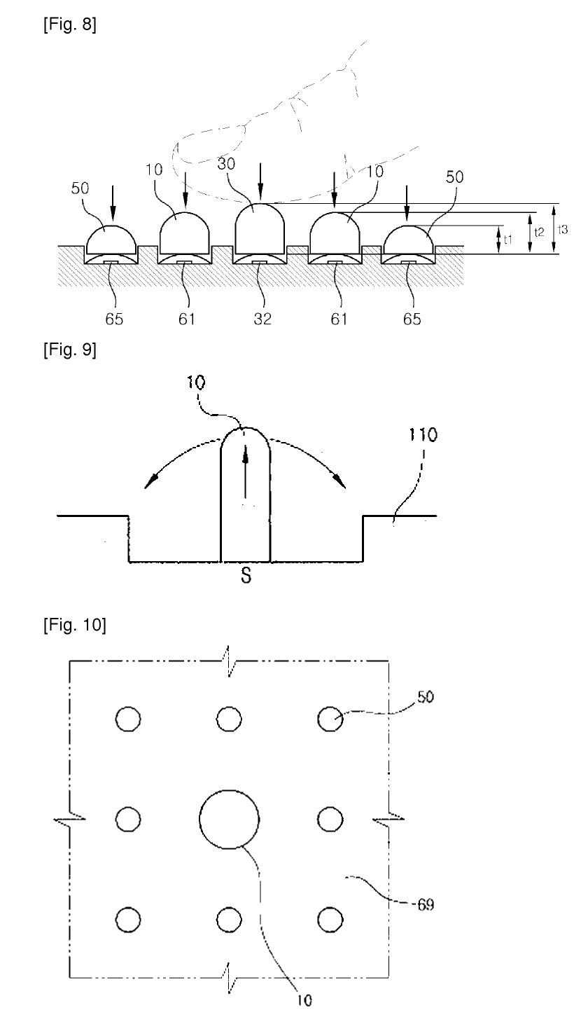

FIG. 7 is a partially cut away perspective view showing a character input device 1 according to a fourth embodiment of the present invention, and FIG. 8 is a sectional view of the character input device 1 of FIG. 7.

Referring to the drawings, both the first directional input unit 10 and the second directional input unit 50 of the character input device 1 according to the present invention may be implemented as ring-shaped integrated type directional input units.

Such a first directional input unit 10 is configured to input a character assigned to each of the first direction indication locations P1₁, P1₂, P1₃, P1₄, . . . and to successively input other data by slidably moving the finger on the first directional input unit 10 without removing the finger from the first directional input unit 10.

For example, in order to input the Korean syllable [symbol] , the character combination [symbol] is completed by primarily inputting the consonant [symbol] of the Korean alphabet, assigned to the second direction indication location P2₁, using the first one of two fingers, and successively inputting the vowel [symbol] of the Korean alphabet, assigned to the first direction indication location P1₁, using the second finger.

In order to successively input the Korean syllable [symbol] , the character combination can be completed by primarily inputting the consonant [symbol] of the Korean alphabet, assigned to the second direction indication location P2₂, by slidably moving the first finger along the second directional input unit 50 without removing the first finger from the second directional input unit 50, and by successively inputting the vowel [symbol] of the Korean alphabet, assigned to the direction indication location P1₃, without removing the second finger from the first directional input unit 10.

A central input key 30 according to the fourth embodiment of the present invention is configured such that the bottom thereof comes into contact with a central input detection unit 32, and a character code, assigned to the central input key 30, can be extracted from memory by the pumping motion of the central input key 30 while the central input key 30 is depressed thus enabling the character code to be input.

Such a central input key 30 can be provided to have various shapes, for example, the shape of a rod, and can be provided to have various sectional areas and heights.

Meanwhile, the central input key 30, the first directional input unit 10 and the second directional input unit 50 are provided to have different heights so that their heights are sequentially reduced. For example, they are configured to satisfy the expression: the height t3 of the central input key 30 above the central input detection unit 32>the height t2 of the first directional input unit 10 above the first directional input detection unit 61>the height t1 of the second directional input unit 50 above the second directional input detection unit 65, thus preventing mutual inference from occurring when respective input operations are performed on the central input key 30, the first directional input unit 10 and the second directional input unit 50.

That is, since the height of the second directional input unit 50 is less than those of the first directional input unit 10 and the central input key 30, second directional input can be performed on the second direction indication locations P2₁, P2₂, P2₃, P2₄, . . . without interference. Since the height of the first directional input unit 10 is greater than that of the second directional input unit 50 and is less than that of the central input key 30, first directional input can be performed on the first direction indication locations P1₁, P1₂, P1₃, P1₄, . . . without interference. Since the height of the central input key 30 is greater than those of the second directional input unit 50 and the first directional input unit 10, central input can be performed by depressing the central input key 30 without interference.

Of course, in reverse order, the central input key 30, the first directional input unit 10 and the second directional input unit 50 may be provided to satisfy the expression: the height t1 of the second directional input unit 50 above the second directional input detection unit 65>the height t2 of the first directional input unit 10 above the first directional input detection unit 61>the height t3 of the central input key 30 above the central input detection unit 32, thus preventing mutual interference from occurring when respective input operations are performed on the second directional input unit 50, the first directional input unit 10 and the central input key 30. Further, the second directional input unit 50, the first directional input unit 10 and the central input key 30 may be provided to have the same height.

FIG. 9 is a sectional view showing a character input device 1 according to a fifth embodiment of the present invention.

As shown in the drawing the character input device 1 according to the fifth embodiment of the present invention is formed in the shape of a stick, in which a lower portion can be supported by a casing 110 and an upper portion can be tilted at each of first direction indication locations P1₁, P1₂, P2₃, P1₄, . . . ,

For example, the first directional input unit 10 may be provided to have the shape of a rod and to have various sectional areas and heights.

When the first directional input unit 10 is provided to have a relatively larger height, the volume of the character input device 1 itself may be increased, so that, as shown in the drawing the first directional input unit 10 may be provided so that it barely protrudes from the casing 110.

Even if the first directional input unit 10 is a tilt-type directional input unit, a touch input function may be assigned to each of the first direction indication locations P1₁, P1₂, P1₃, P1₄, . . . .

Therefore, the touch input function can be applied to one or more of the first directional input unit 10, the second directional input unit 50 and the central input key, without being limited thereto.

FIG. 10 is a plan view showing a character input device 1 according to a fifth embodiment of the present invention.

The character input device 1 according to the fifth embodiment of the present invention is implemented on a touch panel 69. In detail, in a center portion of the touch panel 69, an input location corresponding to a first directional input unit 10 is arranged, and second directional input units 50, corresponding to a plurality of second direction indication locations P2₁, P2₂, P2₃, P2₄, . . . are arranged radially outside the first directional input unit 10.

In this embodiment, a user can manipulate the first directional input unit 10 and the second directional input units 50 using two or more fingers. That is, for example, the second directional input units 50 may be selected using the index or ring finger while directional input is performed using the middle finger.

Therefore, the character input device 1 according to the fifth embodiment of the present invention may be implemented to more efficiently perform character input when the character input device 1 is placed on a table, a support, etc., rather than being held in the hand.

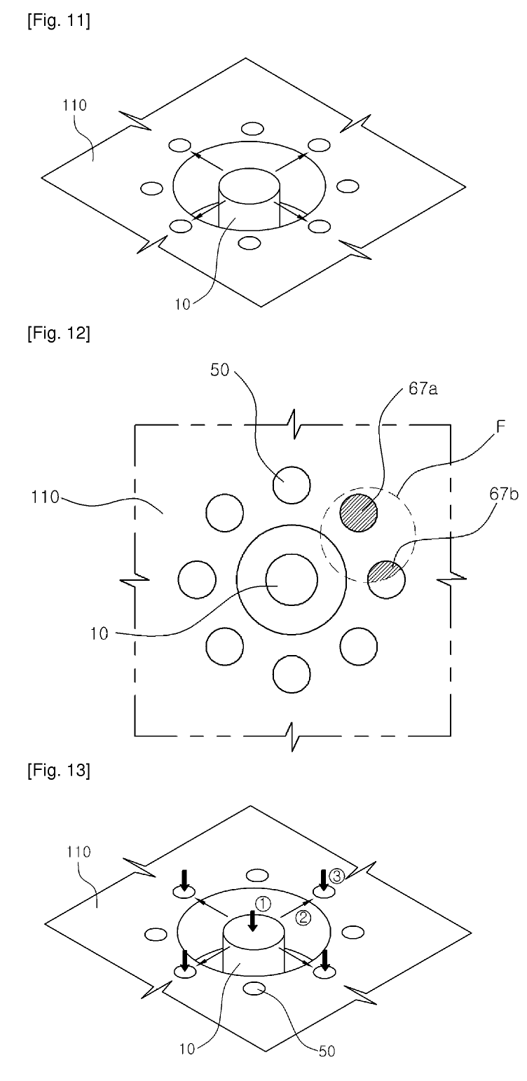

FIG. 11 is a perspective view showing a character input device 1 according to a sixth embodiment of the present invention.

The character input device 1 according to the sixth embodiment of the present invention is characterized in that a first directional input unit 10 and second directional input units 50 are arranged close to each other so that both the input radius of the first directional input unit 10 and the arrangement area of the second directional input units 50 can be selected using one finger.

In this case, as shown in FIG. 11, the first directional input unit 10 may be provided to have the shape of a stick, and the second directional input units 50 may be pressing button-type directional input units or touch detection-type directional input units.

Therefore, the user can contact or press the second directional input units 50 by tilting the thumb or the index finger toward each second directional input unit 50 while putting the center portion of the thumb or the index finger on the top of the first directional input unit 10 and moving the finger in a desired radial direction, thus per forming directional input and external input.

For this operation, as shown in FIGS. 16 to 18, the first directional input unit 10 and the plurality of second directional input units 50 are preferably arranged close to each other so that, in the state in which one of first directional input and second directional input is performed using one finger, the other input is performed without removing the finger from the character input device.

That is, as shown in FIGS. 16 to 18, the first directional input unit 10 and the second directional input unit 50 are configured to fall within the range of motion of one finger, so that, after first directional input is performed on the stick-shaped first directional input unit 10 using a finger (thumb) in a specific direction, second directional input can be freely performed on the second directional input unit 50 in the state in which the finger remains on the first directional input unit 10. In other words, even if the first directional input is performed, the area with which the finger (thumb) can come into contact surrounds the entire portion of the second directional input unit 50, and thus second directional input can be performed regardless of the direction in which first directional input is performed.

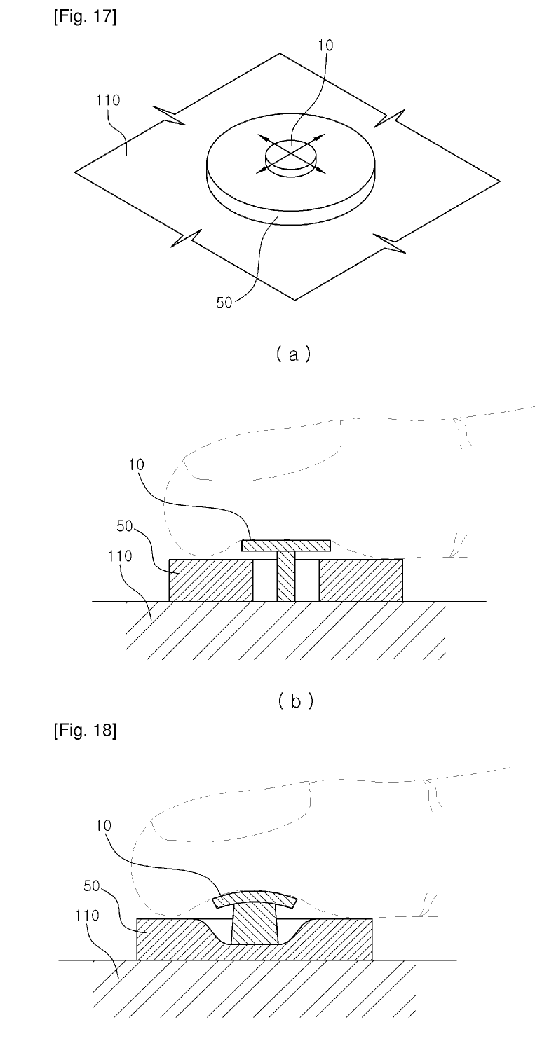

In this case, the second directional input unit 50 may be formed to protrude from the surface of a casing 110 (refer to FIG. 16), or, alternatively, a gap may be formed between the first directional input unit 10 and the second directional input unit 50 (refer to FIGS. 17 and 18), so that the second directional input unit 50 is preferably configured to enable pressing input to be performed even in the state in which the finger remains on the first directional input unit 10. Here, in the shape in which the gap is formed (refer to FIGS. 17 and 18), the second directional input unit 50 is preferably arranged at a lower position than the first directional input unit 10.

Further, the first directional input unit 10 can be provided in another scheme for detecting the slight motion of a finger and performing input, for example, an optical sensor type or a touch type, in addition to a floating type, such as a sliding or stick type.

FIG. 12 is a plan view showing a touch detection method performed using second directional input units 50 in the character input device of FIG. 11.

Referring to the drawing when the character input device 1 is formed to have a small size, as shown in FIG. 11, the problem in which two or more second directional input units 50 are simultaneously selected may occur at the time of selecting the second directional input units 50.

Therefore, in order to solve this problem two or more touch detection units 67a, 67b, . . . may be arranged in each of the second directional input units 50, or touch detection units may be provided in the form of a touch pad, so that only a character assigned to a second directional input unit 50, for which the area detected by the touch detection units is widest or the number of detection units detected by the touch detection units is largest, can be input as an effective character.

Further, as shown in FIGS. 16 to 18, the second directional input units 50 may be configured such that respective second directional input units 50 are connected and integrated into the shape of a ring or a disk, thus enabling second directional input to be determined according to the area of detection. In this case, the detailed shape of the second directional input units 50, formed in a ring or disk shape, may be a circle or a polygon.

The number of characters that can be input according to the present embodiment may be designated as a target number on the basis of the number of first directional input units 10 and second directional input units 50 and the multi-stage input of first directional input units 10 and second directional input units 50.

In addition, through the present embodiment, a larger number of characters can be input by combining central input, performed by pressing the first directional input unit 10, first directional input, performed by moving the first directional input 10, and second directional input, performed by pressing or contacting the second directional input units 50.

That is, as shown in FIG. 13, when first directional input (2 is performed in the state in which central input \textcircled{1} is performed, a new character code assigned to the two overlapping inputs may be input. In this case, instead of the first directional input \textcircled{2}, second directional input \textcircled{3} may be performed.

Further, when central input \textcircled{1} is performed in the state in which first directional input \textcircled{2} is performed, a new character code assigned to the two overlapping inputs may be input. Even in this case, instead of the first directional input \textcircled{2}, the second directional input \textcircled{3} may be performed.

Furthermore, when second directional input \textcircled{3} is performed in the state in which first directional input \textcircled{2} is performed, or when second directional input \textcircled{2} is performed in the state in which second directional input \textcircled{3} is performed, each character code assigned to the two overlapping inputs may be input.

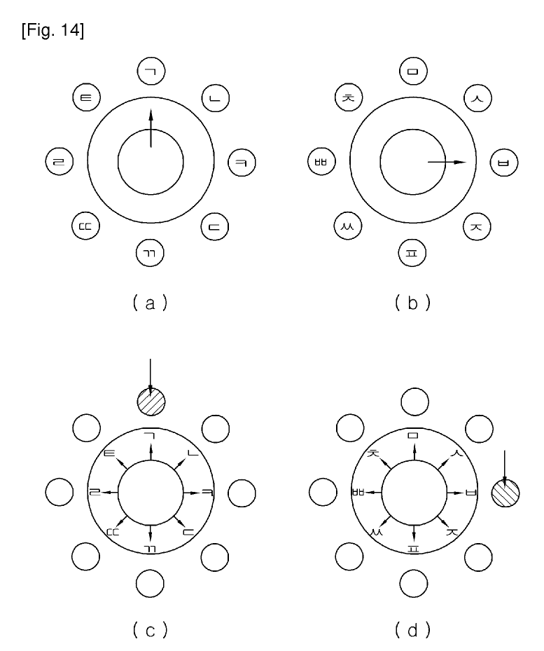

In particular, even in this case, when first directional input is performed in a specific direction, a character assigned to the second direction indication location P2 may be changed by the first directional input. That is, as shown in FIG. 14(a), when first directional input is performed in the direction of 12 o'clock, [symbol] [symbol] [symbol] and [symbol] can be arranged at the second direction indication locations P2₁, P2₂, P2₃, P2₄, . . . . Meanwhile, as shown in FIG. 14(b), when the first directional input is performed in the direction of 3 o'clock, [symbol] [symbol] and [symbol] may be arranged at the second direction indication locations P2₁, P2₂, P2₃, P2₄, . . . .

In this state, second directional input is performed on one of the second direction indication locations P2₁, P2₂, P2₃, P2₄, . . . , to which an intended character is assigned, thus enabling the intended character to be input.

In contrast, when second directional input is performed on a specific one of the second direction indication locations P2₁, P2₂, P2₃, P2₄, . . . , the character assigned by the first directional input may be changed by the second directional input. That is, as shown in FIG. 14(c), when second directional input is performed on the second direction indication location P2, placed in the direction of 12 o'clock, [symbol] [symbol] and [symbol] may be arranged at respective first direction indication locations. Meanwhile, as shown in FIG. 14(d), when second directional input is performed on the second direction indication location P2, placed in the direction of 3 o'clock, [symbol] [symbol] and [symbol] may be arranged at respective first direction indication locations.

In this state, when first directional input is performed, an intended character, among the arranged characters, may be input.

Further, new character codes can be input by performing all of central input, first directional input and second directional input. In this case, input may be performed in the sequence of central input, first or second directional input, and first or second directional input, or in the sequence of first or second directional input, central input, and first or second directional input. Through the series of input operations, a larger number of derivative characters derived from predetermined characters, or a larger number of words, numerals or symbols may be input.

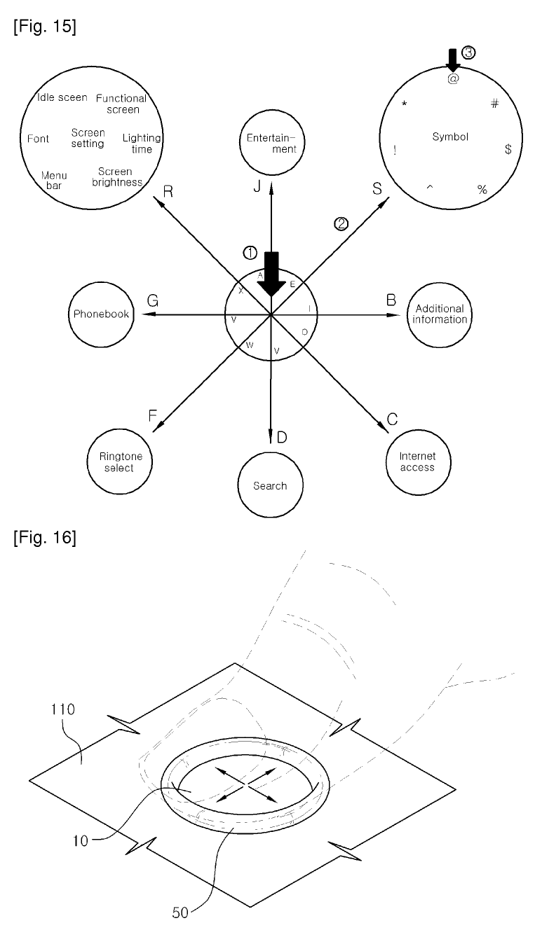

As shown in FIG. 15, when, for example, central input \textcircled{1} is performed, commands, such as ‘symbol’, ‘additional information’, ‘Internet access’, and ‘search’, are arranged at second direction indication locations. At this time, when first directional input \textcircled{2} is performed in the direction of the arrangement of ‘symbol’ in the state in which the central input is performed, ‘@, #, $, %, . . . ,’ belonging to ‘symbol,’ are arranged at the second direction indication locations. Accordingly, in order to select ‘@’ from among the symbols, second directional input \textcircled{3} is performed on the second direction indication location at which ‘@’ is arranged, thus enabling the symbol ‘@’ to be input.

In this way, the function ‘idle screen’ or ‘functional screen’, which is included in the command ‘screen setting’ of FIG. 15, can be set.

Further, through the combination of central input, first directional input, and second directional input, all characters can be arranged, even when the number of characters exceeds 32, as in the case of Hiragana or Katakana of the Japanese or Chinese characters, and, in addition, the characters can be input quickly.

Meanwhile, although not shown in the drawing components for guiding first directional input may be additionally provided in the character input device 1.

In order to input characters in this way, description has been made on the basis of a stick type in the present embodiment, but application to the character input device 1 of the first to fifth embodiments is possible using the same method.

Next, a seventh embodiment of a character input device according to the present invention is described.

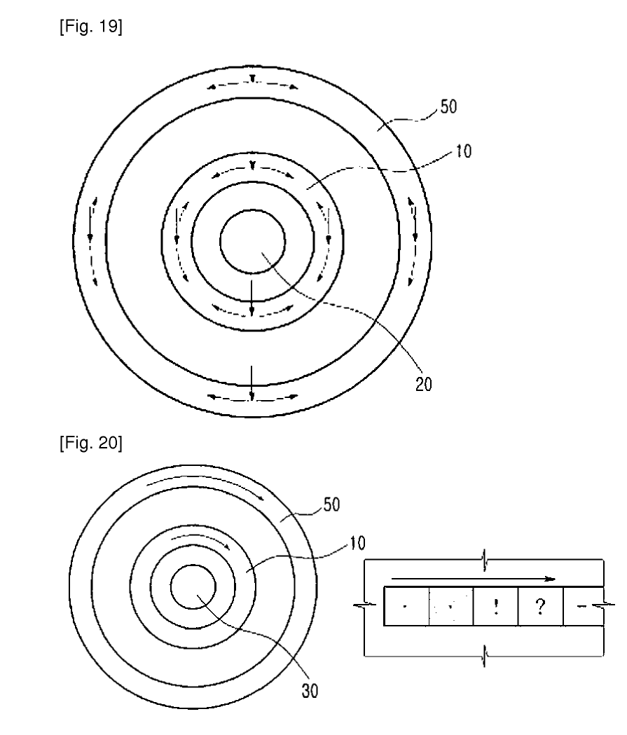

In this embodiment, as shown in FIG. 19, a first directional input unit 10 and a second directional input unit 50 are provided to be rotatable in a circumferential direction.

In this case, the first directional input unit 10 and the second directional input unit 50 are not limited as to the angle of rotation. For example, each of the directional input units 10 and 50 may be rotated one or more turns, or may be rotated within a predetermined angle.

Through the rotational input of the first directional input unit 10 and the second directional input unit 50, various types of data, such as functional commands or separately assigned characters, can be input. Further, it is possible to utilize the first directional input unit 10 and the second directional input unit 50 as touch wheels, using the rotational input of the first and second directional input units 10 and 50.

Meanwhile, as shown in FIG. 20, touch detection means are provided on the top of the first directional input unit 10 and the second directional input unit 50, so that respective directional input units 10 and 50 themselves are not rotated, but rotational input may be performed by bringing the finger into contact with the top of the directional input units and rotating the touch detection means.

In this case, as shown in FIG. 20, a scroll function of selecting sequentially arranged characters according to a rotation angle (or distance) may be performed.

The above-described character input device 1 can be used as an auxiliary input device, such as a mouse or a joystick, as well as a character input device.

That is, after a mode is switched from a character input mode to a mouse mode using a functional key 123 or a switch key 121 mounted on a terminal 100, the first directional input unit 10 can be used as the pointer of the mouse, and the second directional input unit 50 can be used as left/right selection buttons of the mouse.

When the stick-shaped first directional input unit 10 is used, central input on the first directional input unit 10 is used as a left selection button of the mouse, or, alternatively, left/right selection buttons are arranged on the second directional input unit 50 while the first directional input unit 10 is used as the pointer of the mouse, thus enabling selective input to be performed.

Further, in a joystick mode, the movement of characters may be realized at the time of playing a game using the first directional input unit 10 as a joystick, and other commands can be input using the second directional input unit 50.

In addition, in order to control a 3D stereoscopic shape, the character input device 1 according to the present invention may be used. That is, the movement of a 3D object may be performed through first directional input on the first directional input unit 10, and the rotation of the 3D object may be performed in a direction corresponding to second directional input through second directional input on the second directional input unit 50.

Further, directional input may be performed in a circumferential direction through the character input device 1 according to the present invention. That is, after first directional input has been performed in a specific direction, if first directional input is released in the state in which the first directional input unit 10 is rotated at a predetermined angle in the circumferential direction, processing may be performed so that a character, assigned to a first direction indication location P1 before the first directional input unit 10 returns to the reference location or before the final first directional input is terminated, is input.

In particular, when the first directional input unit 10 is formed in the shape of a stick, plane rotation of the above-described 3D object may be performed by rotating the first directional input unit 10 along the circumferential direction after the first directional input has been performed. In this case, the degree of rotation of the 3D object can be adjusted according to the intensity of the rotation of the first directional input unit 10.

In addition, the character input device 1 according to the present invention may further include a center touch detection unit (not shown) placed at the center of the first directional input unit 10 and configured to detect the contact of a finger. The center touch detection unit may be configured to perform touch input, which enables different characters assigned together to the central input key 30 to be input, by detecting approach to the central input key 30 or contact with the central input key 30.

In this case, the control unit may perform input by discriminating between the case where first directional input is performed in the state in which the finger is put on the central input key 30 and the case where first directional input is independently performed.

For example, the control unit can perform control such that, when first directional input is performed by moving the finger in the state in which the finger is brought into contact with the central input key 30 and a center touch detection signal is generated by the center touch detection unit, character ‘A’ is input, and such that, when first directional input alone is performed without bringing the finger into contact with the central input key 30, character ‘B’ is input.

Further, when the contact of the finger is detected for a predetermined period of time or longer, the control unit ignores the results of detection performed by the center touch detection unit, thus preventing touch input from being performed.

Such a center touch detection unit may be implemented such that the function thereof is performed by the central input detection unit 32 of FIG. 3 when the central input detection unit 32 is provided to detect the contact of the finger.

Although the preferred embodiments of the present invention have been disclosed for illustrative purposes, those skilled in the art will appreciate that various modifications, additions and substitutions are possible, without departing from the scope and spirit of the invention.

1. A character input device, comprising: a first directional input unit provided such that first directional input, which is performed through selection of one from among a plurality of first direction indication locations, arranged radially around a reference location and spaced apart from one another, can be performed; a second directional input unit provided such that second directional input, which is performed through selection of one from among a plurality of second direction indication locations, arranged radially outside the first directional input unit and spaced apart from one another, can be performed; a first directional input detection unit configured to detect the first directional input; a second directional input detection unit configured to detect each second directional input; and a control unit configured to extract and input character codes assigned to the first and second direction indication locations on a basis of results of detection of the first directional input detection unit and the second directional input detection unit.

2. The character input device according to claim 1, wherein at least one of the first and second directional input units is provided to enable directional input to be performed in two or more stages, that is, in multiple stages.

3. The character input device according to claim 1, wherein the first and second directional input units are provided in two sets.

4. The character input device according to claim 1, wherein central input that is performed using either one of a method of moving the entire first directional input unit in a vertical direction and a method of selecting a central input key provided on the first directional input unit can be performed.

5. The character input device according to claim 4, wherein, when the first or second directional input is performed in a case in which the central input is performed, a new character code assigned to the case is input.

6. The character input device according to claim 4, wherein, when the central input is performed in a case in which the first or second directional input is performed, a new character code assigned to the case is input.

7. The character input device according to claim 4, wherein, when the first directional input and the second directional input are performed to overlap each other, character codes assigned to the overlapping inputs are input.

8. The character input device according to claim 7, wherein the character codes assigned to the overlapping inputs differ according to a sequence of the first and second directional inputs.

9. The character input device according to claim 1, wherein the first directional input unit is configured to perform the first directional input by horizontally moving toward any one of the plurality of first direction indication locations from the reference location.

10. The character input device according to claim 1, wherein the first directional input unit is formed in a shape of a stick, in which a lower portion is supported at the reference location and an upper portion is tilted at any one of the plurality of first direction indication locations, thus performing the first directional input.

11. The character input device according to claim 1, wherein the first directional input unit is formed in a shape of a disk, and further comprises a support unit, which is placed on a bottom of the first directional input unit and is configured to support the first directional input unit so that the entire first directional input unit can be tilted at each of the first direction indication locations, thus performing the directional input.

12. The character input device according to claim 1, wherein the first directional input unit comprises a plurality of direction pressing keys corresponding to respective first direction indication locations.

13. The character input device according to claim 4, wherein one or more of the first directional input unit, the second directional input unit and the central input key are provided to enable input to be performed in two or more stages, that is, multiple stages.

14. The character input device according to claim 13, wherein one or more of the first directional input unit, the second directional input unit and the central input key are provided to additionally have a touch input function of detecting contact or approach of a finger.

15. The character input device according to claim 14, wherein characters are assigned to one of the first direction indication locations and the second direction indication locations, and symbols, numerals, or functions, such as enter, space, cancel and mode change, are assigned to a remaining one thereof.

16. The character input device according to claim 4, wherein the plurality of second directional input units is connected to each other and implemented as an integrated-type directional input unit.

17. The character input device according to claim 1, wherein the first directional input unit and the plurality of second directional input units are provided close to each other so that, in a state in which one of the first directional input and second directional input is performed using one finger, a remaining one thereof is performed without removing the finger from the character input device.

18. The character input device according to claim 17, wherein the second directional input units are connected and integrated into a shape of a ring.

19. The character input device according to claim 17, wherein the second directional input units are connected and integrated into a shape of a polygon.

20. The character input device according to claim 17, wherein the central input key, the first directional input unit and the second directional input units are provided to have sequentially decreasing heights.

21. The character input device according to claim 17, wherein the first directional input unit and the second directional input units are used as a mouse or a pystick.

22. The character input device according to claim 21, when a mode is switched to a mouse or pystick mode, movement of a mouse pointer or characters is performed using one of the first directional input unit and the second directional input units, and manipulation of left/right buttons of the mouse or manipulation of characters is performed using a remaining one thereof.

23. The character input device according to claim 22, wherein the second directional input units are connected and integrated into a shape of a ring so that continuous operation is possible while sliding on the second directional input units is performed.

24. The character input device according to claim 4, further comprising a center touch detection unit provided on the central input key and configured to detect contact of a finger, wherein the control unit is operated to ignore results of detection performed by the center touch detection unit when contact of the finger is detected by the center touch detection unit for a predetermined period of time or longer, thus preventing touch input from being performed by the center touch detection unit.

25. The character input device according to claim 4, further comprising a center touch detection unit provided on the central input key and configured to detect contact of the finger, wherein the control unit is operated to input different characters by discriminating between a case where a center touch detection signal, obtained through contact of the finger detected by the center touch detection unit, and a detection signal, detected by the first directional input detection unit through performance of the first directional input, are simultaneously received, and a case where only a detection signal, detected by the first directional input detection unit, is received.
